(19) United States
(12) Patent Application Publication
(10) Pub. No.: US 2019/0357068 A1
(43) Pub. Date: Nov. 21, 2019

(54) REPORTING A NUMBER OF EFFECTIVE FREQUENCIES FOR RADIO RESOURCE MANAGEMENT PURPOSES

(71) Applicant: Intel IP Corporation, Santa Clara, CA (US)

(72) Inventors: Candy Yiu, Portland, OR (US); Yang Tang, Pleasanton, CA (US)

(21) Appl. No.: 16/473,663

(22) PCT Filed: Feb. 12, 2018
(86) PCT No.: PCT/US18/17828

§ 371 Date: Jun. 26, 2019

Related U.S. Application Data
(60) Provisional application No. 62/458,427, filed on Feb. 13, 2017.

(51) Int. Cl. H04W 24/10; H04W 72/04; H04L 5/00; H04W 76/27

(52) U.S. Cl. CPC H04W 24/10; H04W 76/27; H04L 5/0092; H04W 72/0453

(57) ABSTRACT

A User Equipment (UE) may receive carrier combinations supported by a Radio Access Network (RAN) node and a list of frequency bands that the RAN node may have the UE measure. The UE may determine all of the possible scenarios of how the carrier combinations may be matched to different sets of frequency bands. For each scenario, the UE may determine the number of effective frequencies based on the quantity of frequency bands in the scenario but only counting frequency bands that the UE may measure in parallel (e.g., at the same time) as a single frequency band. The UE may determine a measurement gap for each component carrier in each scenario, and communicate, to the RAN node, the number of effective frequencies and the measurement gaps for each scenario.

### RELATED APPLICATIONS

The present application claims the benefit of U.S. Provisional Patent Application No. 62/458,427, which was filed on Feb. 13, 2017, the contents of which are hereby incorporated by reference as though fully set forth herein.

### BACKGROUND

Wireless telecommunication networks often include User Equipment (UEs) (e.g., smartphones, tablet computers, laptop computers, etc) that communicate with Radio Access Network (RAN) nodes (e.g., base stations) to connect to and register with a core network. Doing so may provide UEs with access to a variety of network services, such as voice calls, text messages, Internet access, and other data services. The process of a UE connecting to a RAN node may include the UE being assigned wireless resources (e.g., carriers) that the UE may use to communicate with the RAN node. Determining which carriers to assign to a particular UE may include a determination of which carriers (or carrier combinations) are available and supported by the UE and the RAN node. Other factors that may be at issue when assigning resources to the UE may include frequencies that the RAN node may have the UE periodically measure for signaling activity and use, and the measurement capabilities of the UE with respect to those frequencies.

### BRIEF DESCRIPTION OF THE DRAWINGS

Embodiments described herein will be readily understood by the following detailed description in conjunction with the accompanying drawings. To facilitate this description, like reference numerals may designate like structural elements. Embodiments are illustrated by way of example and not by way of limitation in the figures of the accompanying drawings.

FIG. 1 illustrates an architecture of a system of a network in accordance with some embodiments;

FIG. 2 is a flow chart illustrating an example process for Radio Resource Management (RRM) in accordance with the techniques described herein;

FIG. 3 is an example of determining a number of effective frequencies (Nfreq.eff) for measurement frequency bands;

FIG. 4 is an example of determining a measurement gap for each carrier component of each carrier combination and measurement frequency band scenario;

FIG. 5 is an example of information that User Equipment (UE) may send to a Radio Access Network (RAN) node regarding Carrier Aggregation (CA) configurations and measurement frequency bands that the UE previously received from the RAN node;

FIG. 6 illustrates example components of a device in accordance with some embodiments;

FIG. 7 illustrates example interfaces of baseband circuitry m accordance with some embodiments; and

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

### DETAILED DESCRIPTION OF PREFERRED EMBODIMENTS

Radio Resource Management (RRM) in a wireless telecommunication network may include a Radio Access Network (RAN) node (e.g., a base station) providing a User Equipment (UE) with Carrier Aggregation (CA) configurations that may each include one or more carriers (e.g., carrier combinations) supported by the RAN node. The CA configurations may each be associated with a measurement object that includes one or more frequency bands that the UE would periodically measure (e.g., for signaling activity) in combination with using the CA configuration. In some scenarios, measuring the frequency bands may include implementing a measurement gap regarding communications between the UE and the RAN node. A measurement gap may include a duration during which communications between the UE and the RAN node (via the carriers of the selected CA configuration) cease in order to permit the UE to measure signaling activity for the frequency bands of the measurement object.

In some scenarios, the UE may need a measurement gap for a particular measurement object, while in other scenarios the UE may not need a measurement gap. Further, in some scenarios, the UE may need a measurement gap for one frequency band of the measurement object, but not need a measurement gap for another frequency band of the measurement object. Whether a measurement gap is needed may depend on factors that include the band frequencies of the CA configuration and the radio frequency configuration of the UE. For example, if a carrier frequency band and a measured frequency band correspond to the same radio frequency chain with respect to the radio frequency architecture of the UE, the UE may use a measurement gap to perform the measurement. By contrast, if the carrier frequency band and the measured frequency band correspond to different radio frequency chains, with respect to the radio frequency architecture of the UE, a measurement gap may not be required.

Whether a measurement gap is used may impact the performance of the RAN since greater throughput may be possible when the UE may take radio frequency measurements without periodic breaks in communication with the RAN node. As such, RRM may include assigning a CA configuration (e.g. a carrier combination) and measurement object (e g, frequency bands that the UE is to periodically measure) in accordance with whether measurement gaps may be required. However, such an approach may have certain limitations to RRM. For example, in some instance, the UE may be capable of measuring two or more frequencies in parallel (e.g., at the same time). When the UE is able to measure multiple frequency bands in parallel, from a temporal or measurement gap perspective, this may be viewed as the UE effectively measuring multiple frequency bands as though (e.g., during the same measurement gap period) it were only measuring one frequency band.

The techniques described herein may be used to enable RRM techniques that assign CA configurations (e.g., carrier combinations) and measurement objects (e.g., band frequencies that the UE is to measure) based on a combination of the measurement gaps that may (or may not) be required and an ability of the UE to measure certain frequency bands in parallel (e.g., the number of effective radio frequencies). For example, the RAN node may provide the UE with CA configurations supported by the RAN node and frequency bands (referred to herein as “measurement frequency bands”) that (any combination of which) the RAN node may have the UE measure later. The UE may determine, for each CA configuration and possible combination of measurement frequency bands, the number of effective frequency bands (also referred to herein as “Nfreq.eff”) that the UE would be measuring, and whether each component carrier of the CA configuration would use a measurement gap to measure those measurement frequency bands.

As described herein, the effective number of frequency bands may include a total number of frequency band measurements that would be taken by the UE, for a given set of frequency bands, where frequency bands that may be measured in parallel (e.g., at the same time) only count as a single frequency band measurement. The UE may provide the information to the RAN node, and the RAN node may use the information determine the CA configuration, the measurement object, and the measurement gap for communicating with the UE. The RAN node may then inform the UE of the CA configuration, the measurement object, and the measurement gap, and the UE and the RAN node may communicate with one another accordingly.

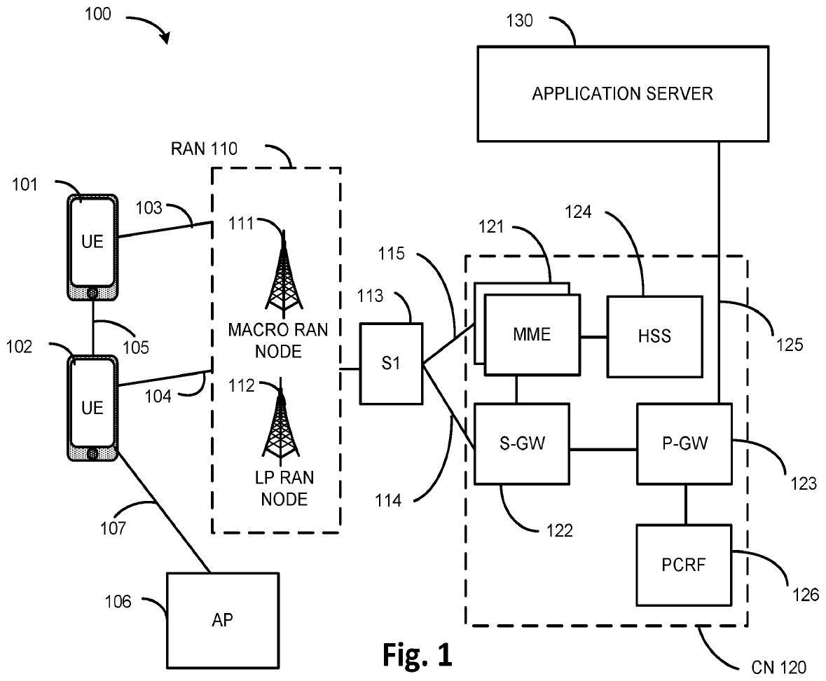

FIG. 1 illustrates an architecture of a system 100 of a network in accordance with some embodiments. The system 100 is shown to include UE 101 and a UE 102. The UEs 101 and 102 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 101 and 102 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc) to facilitate the connections of the IoT network.

The UEs 101 and 102 may be configured to connect, e.g., communicatively couple, with a radio access network (RAN) 110—the RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below): in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTI) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, eNBs, next Generation NodeBs (gNB), RAN nodes, and so forth, and can comprise ground stations (e.g., terrestrial access points) or satellite stations providing coverage within a geographic area (e.g., a cell). The RAN 110 may include one or more RAN nodes for providing macrocells, e.g., macro RAN node 111 (referred to individually as “RAN node 11” and collectively as “RAN nodes 111”), and one or more RAN nodes for providing femtocells or picocells (e.g., cells having smaller coverage areas, smaller user capacity, or higher bandwidth compared to macrocells), e.g., low power (LP) RAN node 112 (referred to individually as “RAN node 112” and collectively as “RAN nodes 112”).

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UEs 101 and 102 can be configured to communicate using Orthogonal Frequency-Division Multiplexing (OFDM) communication signals with each other or with any of the RAN nodes 111 and 112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 and 112 to the UEs 101 and 102, while uplink transmissions can utilize similar techniques. The grid can be a time-frequency grid, called a resource grid or time-frequency resource grid, which is the physical resource in the downlink in each slot. Such a time-frequency plane representation s a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 101 and 102. The physical downlink control channel (PDCCH) may carry information about the transport format and resource allocations related to the PDSCH channel, among other things. It may also inform the UEs 101 and 102 about the transport format, resource allocation, and H-ARQ (Hybrid Automatic Repeat Request) information related to the uplink shared channel. Typically, downlink scheduling (assigning control and shared channel resource blocks to the UE 102 within a cell) may be performed at any of the RAN nodes 111 and 112 based on channel quality information fed back from any of the UEs 101 and 102. The downlink resource assignment information may be sent on the PDCCH used for (e.g., assigned to) each of the UEs 101 and 102.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120—via an S1 interface 113. In embodiments, the CN 120 may be an evolved packet core (EPC) network, a NextGen Packet Core (NPC) network, or some other type of CN. In this embodiment, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this embodiment, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities may include lawful intercept, charging, and some policy enforcement.

The P-GW 123 may terminate an SGi interface toward a PDN. The P-GW 123 may route data packets between the EPC network 123 and external networks such as a network including the application server 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In this embodiment, the P-GW 123 is shown to be communicatively coupled to an application server 130 via an IP communications interface 125. The application server 130 can also be configured to support one or more communication services (e.g., Voice-over-Internet Protocol (VoIP) sessions, PTT sessions, group communication sessions, social networking services, etc) for the UEs 101 and 102 via the CN 120.

The P-GW 123 may further be a node for policy enforcement and charging data collection. Policy and Charging Enforcement Function (PCRF) 126 is the policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with the appropriate traffic flow template (TFT) and QoS class of identifier (QCI), which commences the QoS and charging as specified by the application server 130.

The quantity of devices and/or networks, illustrated in FIG. 1, is provided for explanatory purposes only. In practice, system 100 may include additional devices and/or networks; fewer devices and/or networks: different devices and/or networks: or differently arranged devices and/or networks than illustrated in FIG. 1. For example, while not shown, environment 100X) may include devices that facilitate or enable communication between various components shown in environment 100, such as routers, modems, gateways, switches, hubs, etc. Alternatively, or additionally, one or more of the devices of system 100 may perform one or more functions described as being performed by another one or more of the devices of system 100). Additionally, the devices of system 100 may interconnect with each other and/or other devices via wired connections, wireless connections, or a combination of wired and wireless connections In some embodiments, one or more devices of system (X) may be physically integrated in, and/or may be physically attached to, one or more other devices of system 100). Also, while “direct” connections may be shown between certain devices in FIG. 1, some of said devices may, in practice, communicate with each other via one or more additional devices and/or networks.

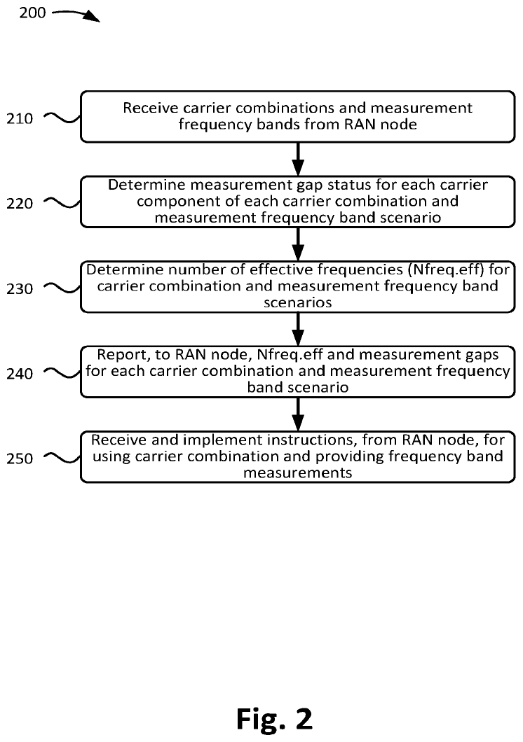

FIG. 2 is a flow chart illustrating an example process 2100 for RRM in accordance with the techniques described herein. Process 200 may be performed by UE 101.

As shown, process 200 may include receiving carrier combinations and measurement frequency bands from RAN node 111 (block 210). For example, UE 101 may receive CA configurations, from RAN node 1, which may include sets of carriers (e.g., carrier combinations) supported by RAN node 111. UE 101 may also receive, from RAN node 111, an indication of the frequency bands (any combination of which) RAN node 111 may later assign to UE 101 to periodically measure and report back on for RRM purposes. For conciseness, frequency bands provided to UE 101 for potential measurement purposes may be referred to herein as “measurement frequency bands.”

Process 200 may include determining a measurement gap status for each component carrier of each carrier combination and measurement frequency band scenario (block 220). For example, each carrier combination may include multiple component carriers (e.g., carriers that are each a component to the carrier combination). As such, for each carrier combination and measurement frequency band scenario, UE 101 may determine whether UE 101 would use a measurement gap to measure the corresponding measurement frequency bands of that scenario. As mentioned above, whether the UE may use a measurement gap for a particular measurement frequency band may be based on the component carriers of the CA configuration, the measurement frequency band, and the radio frequency configuration and architecture of the UE itself. For example, if a carrier frequency band and a measured frequency band correspond to the same radio frequency chain with respect to the radio frequency architecture of the UE, the UE may need to use a measurement gap to perform the measurement. By contrast, if the carrier frequency band and the measurement frequency band correspond to different radio frequency chains, with respect to the radio frequency architecture of the UE, a measurement gap may not be needed. In some embodiments, determining a measurement gap status may include determining whether a measurement gap would be used (e.g., gap needed or gap not need) and/or determining that a network controlled small gap (NCSG) would be used. As described below, UE 101 may determine the measurement gap status (e.g., gap needed, no gap needed, or NCSG) for different measurement frequency bands, but the RAN node 111 may have the final say to gap scheduling (e.g., when measurements are scheduled, the duration of the measurement gap, etc.).

Process 200 may also include determining a number of effective frequencies (Nfreq.eff) for each carrier combination and measurement frequency band scenario (block 230). UE 101 may determine the Nfreq.eff corresponding to each scenario by determining the measurement frequency bands that UE 101 may measure in parallel (e.g., at the same time), the measurement frequency band(s) that UE 101 may not measure in parallel, and summing a total (or effective) number of measurement frequency bands that UE 101 would measure for that scenario, where frequency bands that can be measured in parallel are counted as a single frequency for purposes of determining Nfreq.eff for the scenario. For example, assume the measurement frequency bands for a given scenario are frequency bands 1, 2, 3, 4, and that UE 101 may measure frequency bands 1 and 3 in parallel but frequency bands 2 and 4 could not. UE 101 may determine that the Nfreq.eff for such a situation is 3 since there are 4 frequency bands but frequency bands 2 and 4 may be measured in parallel and therefore only count as 1 “effective” frequency band.

Process 200 may include reporting, to RAN node 111, the Nfreq.eff and measurement gap status for each carrier combination and measurement frequency band scenario (block 240). For example, UE 101 may communicate, to RAN node 111, the Nfreq.eff for each carrier combination and measurement frequency band scenario determined by UE 101. Additionally, UE 101 may provide RAN node 111 with an indication of the needed measurement gap (or lack thereof) that may correspond to each carrier component of the carrier combination and measurement frequency band scenario. As such, RAN node 111 may receive an indication of an ability of UE 101 to provide frequency band measurements for any combination of CA configuration (e.g., combination of carriers) and corresponding measurement frequency bands. More particularly, UE 101 may inform RAN node 111 of the measurement gaps that may be used, per component carrier, and the number of effective measurement frequency bands that may be measured, for each possible carrier combination and measurement frequency band scenario.

Process 200 may include receiving, from RAN node 111, instructions for using a carrier combination and providing frequency band measurements (block 250). For example, in response to providing RAN node 111 with information describing the capabilities of UE 101 to provide frequency band measurements for different carrier combination and measurement frequency band scenarios, RAN node 111 may determine a CA configuration and a measurement object suitable for UE 101 and provide UE 101 with instructions corresponding to the use or implementation thereof. The CA configuration may identify a carrier combination to be used by UE 101 for communicating with RAN node 111, and the measurement object may indicate frequency bands to be measured by UE 101. RAN node 111 may also provide UE 101 with information regarding measurement gaps that UE 101 may use for measuring the frequency bands of the measurement object and/or information about reporting the measurements to RAN node 111 (e.g., RAN node 111 may provide measurement gap scheduling information to UE 101).

Process 200 (or one or more aspects of process 200) may be implemented by, and/or during, a Radio Resource Control (RRC) procedure of the 3GPP Wireless Communication Standard. For instance, RAN node 111 may send UE 101 a RRC Connection Reconfiguration message that may include a perCC-Gap Indication. This may prompt or otherwise cause UE 101 to determine a Nfreq.eff for each carrier combination and a measurement gap for each component carrier. Additionally. UE 101 may respond to RAN node 111 by sending an RRC Connection Reconfiguration Complete message that includes the Nfreq.eff for each carrier combination and the needed measurement gaps for each component carrier. The Nfreq.eff for each carrier combination may be indicated as a numFreqEffective IE, and the measurement gaps may be indicated by a perCC-ListGapIndication IE. In some embodiments, other RRC messages and/or IEs may be used to implement one or more aspects of process 200.

In some embodiments, RRM may be provided using additional and/or alternative operations and procedures than what is represented in FIG. 2. For example, in some embodiments, RAN node 111 may send the CA configurations and measurement frequency bands to UE 101, and UE 101 may determine, and report back to RAN node 111, the measurement frequency bands that may be measured in parallel (e.g., within the same measurement gap), for each CA configuration. In some embodiments, UE 101 may also determine, and provide RAN node 111 with, an estimated measurement gap for measuring the measurement frequency bands associated with the CA. Based on the information received from UE 101, RAN node 111 may determine and allocated a CA configuration (e.g., a combination of carriers) and a measurement object (e.g., one or more measurement frequency bands) to UE 101.

In response. UE 101 may determine and report (to RAN node 111) measurement gap preferences based on the allocation from RAN node 111, and RAN node 111 may arrange, rearrange, configure, reconfigure, etc., communications with UE 101 based on the measurement gap preferences from UE 101.

In some embodiments. UE 101 may only report Nfreq.eff values for measurement frequency bands that correspond to radio frequency chains that are already active and being used by UE 101. In such a scenario, UE 101 may not report Nfreq.eff values corresponding to inactive or non-used radio frequency chains, which may enable UE 101 to conserve power (e.g., battery power) by preventing RAN node 111 from assigning, causing, etc., UE 101 to provide frequency bands measurements for certain frequency bands. In other embodiments, UE 101 may instead report Nfreq.eff values for all radio frequency chains.

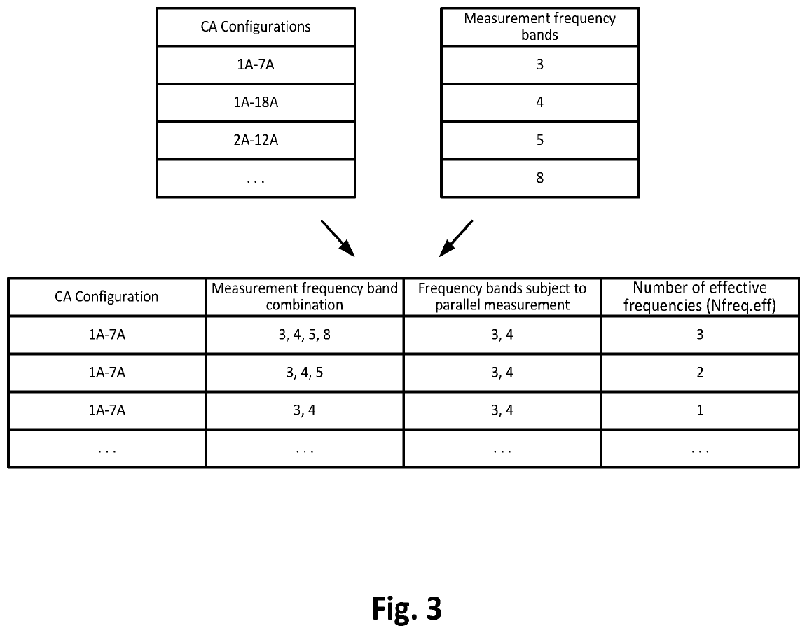

FIG. 3 is an example of determining a number of effective frequencies (Nfreq.eff) for measurement frequency bands. The annotations and representations provided in FIG. 3 to represent CA configurations, carriers, carrier combinations, measurement frequency bands, etc., are provided for explanatory purposes only. In practice, the techniques described herein may use different annotations and representations than those explicitly provided in FIG. 3.

UE 101 may receive CA configurations and measurement frequency bands from RAN node 111. The CA configurations may include carrier combinations (e.g., 1A-7A, 1A-18A, and 2A-12A, etc.) that are supported by RAN node 111. UE 101 may also receive measurement frequency bands, anyone or combination of which. RAN node 111 may later assign UE 101 to periodically measure and report about to RAN node 111. The measurement frequency bands of FIG. 3 include frequency bands 3, 4, 5, and 8.

Base on the CA configurations and the measurement frequency bands, UE 101 may determine a number of effective frequencies that corresponds to each possible scenario of CA configurations and measurement frequency bands. For instance, as shown in FIG. 3. UE 101 may determine that for the carrier combination 1A-7A the possible measurement frequency bands include a combination of frequency bands 3, 4, 5, and 8, a combination of frequency bands 3, 4, and 5, a combination of frequency bands 3 and 4, etc. Based on a given carrier combination (e.g., 1A-7A) and corresponding set of measurement frequency bands (e.g., 3, 4, 5, and 8, etc.) UE 101 may determine whether any of the measurement frequency bands may, be measured in parallel and determine a corresponding Nfreq.eff where frequency bands that can be measured in parallel are only counted once. For example, for the measurement frequency band combination of frequency bands 3, 4, 5, and 8. UE 101 may measure frequency bands 3 and 4 in parallel (at the same time). As such, when determining the Nfreq.eff for the scenario of the carrier combination of 1A-7A and measurement frequency bands 3, 4, 5, and 8. UE 101 may determine Nfreq.eff to be 3 (i.e., 1 count for measurement frequency band 5, 1 count for frequency band 8, and 1 count for measurement frequency bands 3 and 4 (since UE 101 may measure frequency bands 3 and 4 in parallel) UE 101 may determine the Nfreq.eff for each possible scenario of CA configurations and measurement frequency bands in a similar manner.

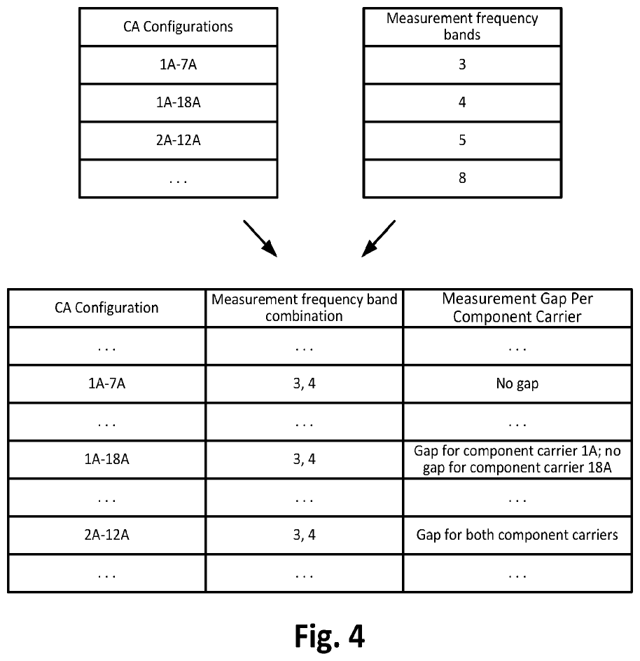

FIG. 4 is an example of determining a measurement gap for each carrier component of each carrier combination and measurement frequency band scenario. As described above with reference to FIG. 3, RAN node 110 may provide UE 101 with CA configurations that are supported by RAN node 110 and measurement frequency bands (i.e., frequency bands that RAN node 110 may assign to UE 101 for measuring and reporting activity and usage). Additionally, UE 101 may determine all of the possible arrangements or scenarios regarding the CA configurations and measurement frequency bands provided. For example, as shown in FIG. 4, UE 101 may determine a potential scenario in which the CA configuration of 1A-7A is assigned to UE 101 along with a measurement object that includes frequency bands 3 and 4.

Similar examples are shown in FIG. 4 with respect the CA configuration of carrier combinations 1A-18A and 2A-12A. For each component carrier of the CA configuration, UE 101 may determine a whether a measurement gap would be used to provided measurement services for the corresponding measurement frequency bands (e.g., measurement frequency bands 3 and 4). As discussed above, whether UE 101 may use a measurement gap for a particular measurement frequency band may depend on several factors, such as the individual carrier components of the corresponding CA configuration (i.e., each carrier of the carrier combination of the CA configuration) and whether the radio frequency structure or architecture of the UE itself is such that there is a functional overlap or protentional conflict between using the carrier component to communicate with RAN node 111 and taking measurements for the corresponding measurement frequency band.

Accordingly, as shown in the example of FIG. 4, UE 101 may determine that no measurement gap would be applicable to a scenario involving the CA configuration of bands 1A-7A and a measurement object that includes frequency bands 3 and 4. In another example, UE 101 may determine that for a scenario involving a CA configuration of bands 1A-18A, and a measurement object that includes frequency bands 3 and 4, a measurement gap may be applicable for component carrier 1A but not for component carrier 18A. In another example, UE 101 may determine that for a scenario involving a CA configuration of bands 2A-12A, and a measurement object that includes frequency bands 3 and 4, a measurement gap may be applicable for component carriers 2A and 12A to measure frequency bands 3 and 4. As such, UE 101 may determine, for every possible scenario of a CA configuration and set of measurement frequency bands, whether a measurement hap would be applicable to any of the component carriers ((i.e., an individual carrier of the combustion of carriers indicated in a CA configuration) of the CA configurations provided, and supported, by RAN node 111.

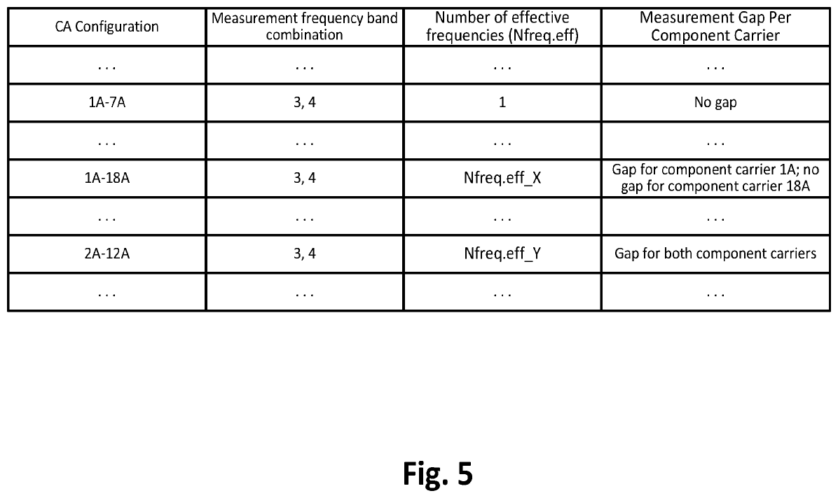

FIG. 5 is an example of information that UE 101 may send to RAN node 111 regarding CA configurations and measurement frequency bands that UE 101 previously received from RAN node 11. As discussed with respect to FIGS. 3 and 4, based on the CA configurations and measurement frequency bands form RAN node 111, UE 101 may determine every possible scenario, combination, arrangement, etc., of a CA configuration associated with one or more measurement frequency bands Additionally, for each of these possible scenarios. UE 101 may determine an Nfeq.eff value that indicates the total, effective number of measurement frequency bands that UE 101 may measure in a particular scenario, where measurement frequency bands that UE 101 may measure in parallel (e.g., simultaneously) are counted as a measurement of only one of the measurement frequency bands of the scenario. Additionally, for each CA configuration and measurement frequency band combination, UE 101 may determine, for each component carrier of the CA configuration, whether a measurement gap is applicable. As such, UE 101 may indicate, to RAN node 111, the Nfreq.eff and measurement gaps (per component carrier) for all possible scenarios given the CA configurations and measurement frequency band combinations received form RAN node 111.

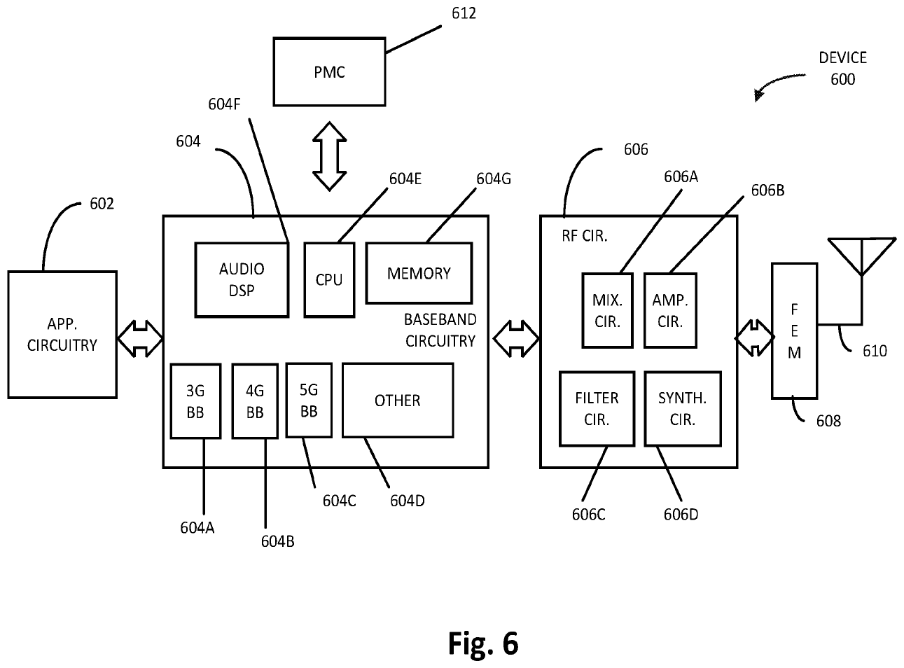

Embodiments described herein may be implemented into a system using any suitably configured hardware and/or software. FIG. 6 illustrates example components of a device 600 in accordance with some embodiments. In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE or a RAN node. In some embodiments, the device 600 may include less elements (e.g., a RAN node may not utilize application circuitry 602, and instead include a processor/controller to process IP data received from an EPC). In some embodiments, the device 600X) may include additional elements such as, for example, memory/storage, display, camera, sensor, or input/output (I/O) interface. In other embodiments, the components described below may be included in more than one device (e.g. said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 6040 and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo. Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC.)

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 66 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 6i0c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 60a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited m this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g. based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604. However, in other embodiments, the PMC 612 may be additionally or alternatively coupled with, and perform similar power management operations for, other components such as, but not limited to, application circuitry 602. RF circuitry 606, or FEM 608.

In some embodiments, the PMC 612 may control, or otherwise be part of, various power saving mechanisms of the device 600. For example, if the device 600 is in an RRC_Connected state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it must transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described m further detail below. As referred to herein. Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

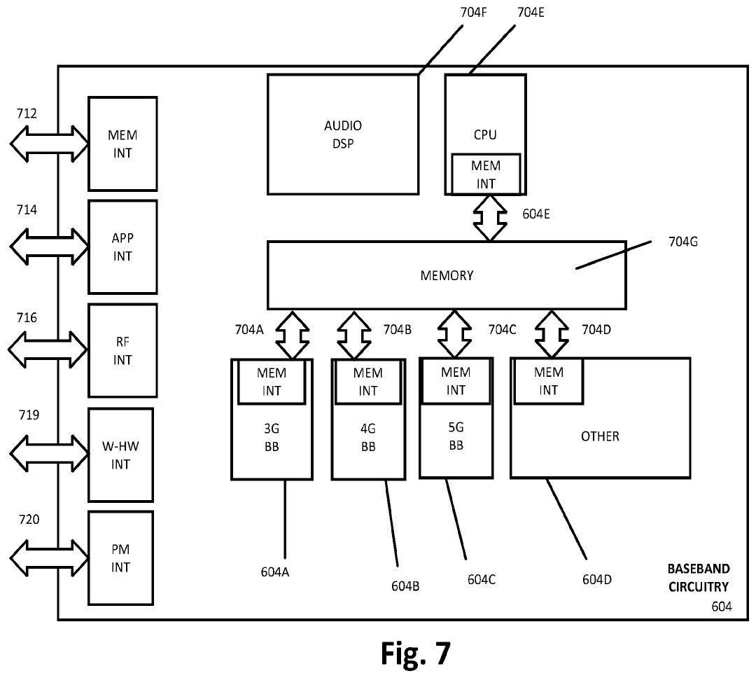

FIG. 7 illustrates example interfaces of baseband circuitry in accordance with some embodiments. As discussed above, the baseband circuitry 604 of FIG. 6 may comprise processors 604A-504E and a memory 604G utilized by said processors. Each of the processors 604A-504E may include a memory interface, 704A-604E, respectively, to send/receive data to/from the memory 704G.

The baseband circuitry 704 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 716 (e.g., an interface to send/receive data to/from Near Field Communication (NFC) components, Bluetooth® components (e.g., Bluetooth®, Low Energy), Wi-Fi® components, and other communication components), and a power management interface 720 (e.g., an interface to send/receive power or control signals to/from the PMC 612).

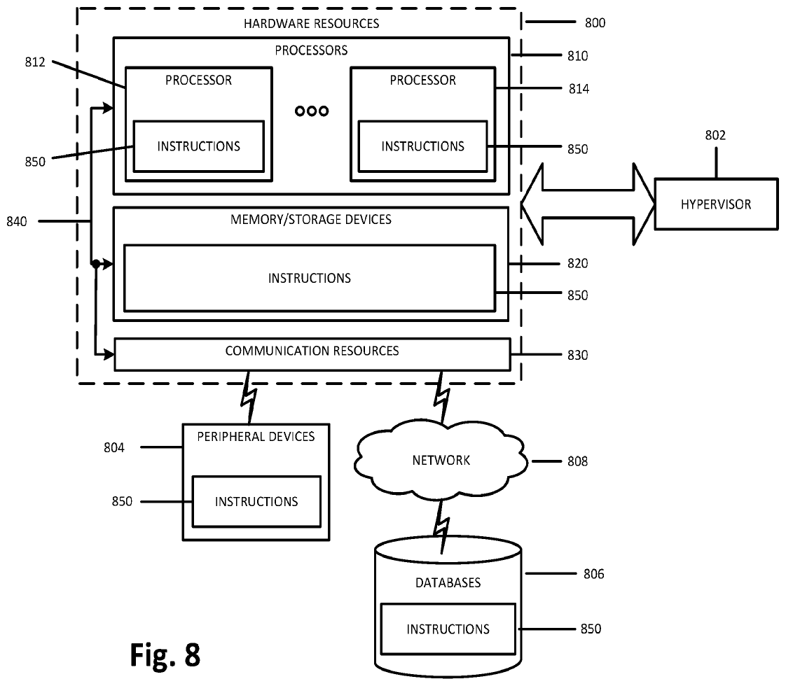

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800) including one or more processors (or processor cores) 810, one or more memory/storage devices 820, and one or more communication resources 830, each of which may be communicatively coupled via a bus 840. For embodiments where node virtualization (e.g., NFV) is utilized, a hypervisor 802 may be executed to provide an execution environment for one or more network slices/sub-slices to utilize the hardware resources 800

The processors 810 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 812 and a processor 814.

The memory/storage devices 820 may include main memory, disk storage, or any suitable combination thereof. The memory/storage devices 820 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 830 may include interconnection or network interface components or other suitable devices to communicate with one or more peripheral devices 804 or one or more databases 806 via a network 808. For example, the communication resources 830 may include wired communication components (e.g., for coupling via a Universal Serial Bus (USB)), cellular communication components, NFC components. Bluetooth® components (e.g., Bluetooth® Low Energy), Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

A number of examples, relating to embodiments of the techniques described above, will next be given.

In a first example, an apparatus of a User Equipment (UE) may comprise: an interface to radio frequency (RF) circuitry; and one or more processors to: match a carrier combination supported by a Radio Access Network (RAN) node to a plurality of frequency bands used by the RAN node, the carrier combination including a plurality of component carriers; determine two or more frequency bands, of the plurality of frequency bands, that the UE can measure in parallel; determine a number of effective frequency bands, based on a total number of the plurality of frequency bands, where the two or more frequency bands that UE can measure in parallel are considered, in determining the number of effective frequency bands, as a single frequency band; identify a measurement gap status for each component carrier of the plurality of component carriers: and communicate, via the interface to the RF circuitry and to the RAN node, the number of effective frequency bands and the measurement gap status for each component carrier of the plurality of component carriers.

In example 2, the subject matter of example 1, or any of the examples herein, wherein the one or more processors are further to: receive the carrier combination and the plurality of frequency bands from the RAN node.

In example 3, the subject matter of example 1, or any of the examples herein, wherein the one or more processors are further to: receive an indication, from the RAN node, to use the carrier combination for communicating with the RAN node.

In example 4, the subject matter of example 1 or 3, or any of the examples herein, wherein the one or more processors are further to: receive an indication, from the RAN node, to periodically measure signaling activity of the plurality of frequency bands.

In example 5, the subject matter of example 4, or any of the examples herein, wherein the one or more processors are further to: measure signaling activity for the two or more frequency bands simultaneously.

In example 6, the subject matter of example 1, 3, 4, or 5, or any of the examples herein, wherein the UE operates in a New Radio (NR) Radio Access Technology (RAT) environment of the RAN node.

In a seventh example, an apparatus of a User Equipment (UE) may comprise: an interface to radio frequency (RF) circuitry, and one or more processors to receive, via the interface to the RF circuitry and from a Radio Access Network (RAN) node, a plurality of carrier combinations supported by the RAN node and a plurality of frequency bands used by the RAN node, each carrier combination including at least one component carrier, determine a number of effective frequency bands for each possible combination of a carrier combination, of the plurality of carrier combinations, matched to at least one frequency band of the plurality of frequency bands, the number of effective frequency bands being equal to the number of the at least one frequency band where frequency bands that UE may measure simultaneously are considered as being only one frequency band: determine a measurement gap status for each component carrier of each possible combination, communicate, via the interface to the RF circuitry and to the RAN node, the number of effective frequency bands and the measurement gap status each possible combination; receive, via the interface to the RF circuitry and from the RAN node, instructions for using a particular carrier combination, of the plurality of carrier combinations, to communicate with the RAN node and providing periodic radio frequency measurements for one or more radio frequencies of the plurality of radio frequencies.

In example 8, the subject matter of example 7, or any of the examples herein, wherein the one or more processors are further to: measure signaling activity for the one or more radio frequency in accordance with measurement gap scheduling information received from the RAN node.

In example 9, the subject matter of example 7 or 8, or any of the examples herein, wherein the UE operates in a New Radio (NR) Radio Access Technology (RAT) environment of the RAN node.

In a tenth example, a computer-readable medium containing program instructions for causing one or more processors, associated with a User Equipment (UE), to: match a carrier combination supported by a Radio Access Network (RAN) node to a plurality of frequency bands used by the RAN node, the carrier combination including a plurality of component carriers: determine two or more frequency bands, of the plurality of frequency bands, that the UE can measure in parallel: determine a number of effective frequency bands, based on a total number of the plurality of frequency bands, where the two or more frequency bands that UE can measure in parallel are considered, in determining the number of effective frequency bands, as a single frequency band; identify a measurement gap status for each component carrier of the plurality of component carriers: and communicate, to the RAN node, the number of effective frequency bands and the measurement gap status for each component carrier of the plurality of component carriers.

In example 11, the subject matter of example 10, or any of the examples herein, wherein the one or more processors are further to: receive the carrier combination and the plurality of frequency bands from the RAN node.

In example 12, the subject matter of example 10, or any of the examples herein, wherein the one or more processors are further to: receive an indication, from the RAN node, to use the carrier combination for communicating with the RAN node.

In example 13, the subject matter of example 10 or 12, or any of the examples herein, wherein the one or more processors are further to: receive an indication, from the RAN node, to periodically measure signaling activity of the plurality of frequency bands.

In example 14, the subject matter of example 13, or any of the examples herein, wherein the one or more processors are further to: measure signaling activity for the two or more frequency bands simultaneously.

In example 15, the subject matter of example 10, 12, 13, or 14, or any of the examples herein, wherein the UE operates in a New Radio (NR) Radio Access Technology (RAT) environment of the RAN node.

In a sixteenth example, a method performed by a User Equipment (UE) may comprise: matching a carrier combination supported by a Radio Access Network (RAN) node to a plurality of frequency bands used by the RAN node, the carrier combination including a plurality of component carriers: determining two or more frequency bands, of the plurality of frequency bands, that the UE can measure in parallel; determining a number of effective frequency bands, based on a total number of the plurality of frequency bands, where the two or more frequency bands that UE can measure in parallel are considered, in determining the number of effective frequency bands, as a single frequency band; identifying a measurement gap status for each component carrier of the plurality of component carriers; and communicating, to the RAN node, the number of effective frequency bands and the measurement gap status for each component carrier of the plurality of component carriers.

In example 17, the subject matter of example 16, or any of the examples herein, further comprising: receiving the carrier combination and the plurality of frequency bands from the RAN node.

In example 18, the subject matter of example 16, or any of the examples herein, further comprising: receiving an indication, from the RAN node, to use the carrier combination for communicating with the RAN node.

In example 19, the subject matter of example 16 or 18, or any of the examples herein, further comprising: receiving an indication, from the RAN node, to periodically measure signaling activity of the plurality of frequency bands.

In example 20, the subject matter of example 19, or any of the examples herein, further comprising: measuring signaling activity for the two or more frequency bands simultaneously In example 21, the subject matter of example 16, 18, 19, or 20, or any of the examples herein, wherein the UE operates in a New Radio (NR) Radio Access Technology (RAT) environment of the RAN node.

In a twenty-second example, an apparatus of a User Equipment (UE) may comprise: means for matching a carrier combination supported by a Radio Access Network (RAN) node to a plurality of frequency bands used by the RAN node, the carrier combination including a plurality of component carriers, means for determining two or more frequency bands, of the plurality of frequency bands, that the UE can measure in parallel; means for determining a number of effective frequency bands, based on a total number of the plurality of frequency bands, where the two or more frequency bands that UE can measure in parallel are considered, in determining the number of effective frequency bands, as a single frequency band; means for identifying a measurement gap status for each component carrier of the plurality of component carriers: and means for communicating, to the RAN node, the number of effective frequency bands and the measurement gap status for each component carrier of the plurality of component carriers.

In example 23, the subject matter of example 22, or any of the examples herein, further comprising: means for receiving the carrier combination and the plurality of frequency bands from the RAN node.

In example 24, the subject matter of example 22, or any of the examples herein, further comprising: means for receiving an indication, from the RAN node, to use the carrier combination for communicating with the RAN node.

In example 25, the subject matter of example 22 or 24, or any of the examples herein, further comprising: means for receiving an indication, from the RAN node, to periodically measure signaling activity of the plurality of frequency bands.

In example 26, the subject matter of example 25, or any of the examples herein, further comprising: means for measuring signaling activity for the two or more frequency bands simultaneously.

In example 27, the subject matter of example 22, 24, 25, or 26, or any of the examples herein, wherein the UE operates in a New Radio (NR) Radio Access Technology (RAT) environment of the RAN node.

In the preceding specification, various embodiments have been described with reference to the accompanying drawings. It will, however, be evident that various modifications and changes may be made thereto, and additional embodiments may be implemented, without departing from the broader scope as set forth in the claims that follow. The specification and drawings are accordingly to be regarded in an illustrative rather than restrictive sense.

For example, while series of signals and/or operations have been described with regard to FIGS. 2-4 the order of the signals/operations may be modified in other implementations. Further, non-dependent signals may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to be limiting. In fact, many of these features may be combined in ways not specifically recited in the claims and/or disclosed in the specification.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used.

1-25. (canceled)

26. An apparatus of a User Equipment (UE), the apparatus comprising:
an interface to radio frequency (RF) circuitry; and
one or more processors to:
match a carrier combination supported by a Radio Access Network (RAN) node to a plurality of frequency bands used by the RAN node, the carrier combination including a plurality of component carriers;
identify a measurement gap status for each component carrier of the plurality of component carriers;
determine two or more frequency bands, of the plurality of frequency bands, that the UE can measure in parallel;
determine a number of effective frequency bands, based on a total number of the plurality of frequency bands, where the two or more frequency bands that UE can measure in parallel are considered, in determining the number of effective frequency bands, as a single frequency band; and
communicate, via the interface to the RF circuitry and to the RAN node, the number of effective frequency bands and the measurement gap status for each component carrier of the plurality of component carriers.

27. The apparatus of claim 26, wherein the one or more processors are further to:
receive the carrier combination and the plurality of frequency bands from the RAN node.

28. The apparatus of claim 26, wherein the one or more processors are further to:
receive an indication, from the RAN node, to use the carrier combination for communicating with the RAN node.

29. The apparatus of claim 26, wherein the one or more processors are further to:
receive an indication, from the RAN node, to periodically measure signaling activity of the plurality of frequency bands.

30. The apparatus of claim 29, wherein the one or more processors are further to:
measure signaling activity for the two or more frequency bands simultaneously.

31. The apparatus of claim 26, wherein the UE operates in a New Radio (NR) Radio Access Technology (RAT) environment of the RAN node.

32. An apparatus of a User Equipment (UE), the apparatus comprising:
an interface to radio frequency (RF) circuitry; and
one or more processors to:
receive, via the interface to the RF circuitry and from a Radio Access Network (RAN) node, a plurality of carrier combinations supported by the RAN node and a plurality of frequency bands used by the RAN node, each carrier combination including a plurality of component carriers;
determine a measurement gap status for each component carrier of each possible combination of a carrier combination, of the plurality of carrier combinations, and at least one frequency band of the plurality of frequency bands;
determine a number of effective frequency bands for each possible combination, where frequency bands that UE can measure in parallel are considered as being only one frequency band for purposes of determining the number of effective frequency bands;
communicate, via the interface to the RF circuitry and to the RAN node, the number of effective frequency bands and the measurement gap status of each possible combination;
receive, via the interface to the RF circuitry and from the RAN node, instructions for using a particular carrier combination, of the plurality of carrier combinations, to communicate with the RAN node and for periodically measuring one or more radio frequencies of the plurality of radio frequencies.

33. The apparatus of claim 32, wherein the one or more processors are further to:
measure signaling activity for the one or more radio frequency in accordance with measurement gap scheduling information of the instructions received from the RAN node.

34. The apparatus of claim 32, wherein the UE operates in a New Radio (NR) Radio Access Technology (RAT) environment of the RAN node.

35. A computer-readable medium containing program instructions for causing one or more processors, associated with a User Equipment (UE), to:
match a carrier combination supported by a Radio Access Network (RAN) node to a plurality of frequency bands used by the RAN node, the carrier combination including a plurality of component carriers;
identify a measurement gap status for each component carrier of the plurality of component carriers;
determine two or more frequency bands, of the plurality of frequency bands, that the UE can measure in parallel;
determine a number of effective frequency bands, based on a total number of the plurality of frequency bands, where the two or more frequency bands that UE can measure in parallel are considered, in determining the number of effective frequency bands, as a single frequency band; and
communicate, to the RAN node, the number of effective frequency bands and the measurement gap status for each component carrier of the plurality of component carriers.

36. The computer-readable medium of claim 35, wherein the one or more processors are further to:
receive the carrier combination and the plurality of frequency bands from the RAN node.

37. The computer-readable medium of claim 35, wherein the one or more processors are further to:
receive an indication, from the RAN node, to use the carrier combination for communicating with the RAN node.

38. The computer-readable medium of claim 35, wherein the one or more processors are further to:
receive an indication, from the RAN node, to periodically measure signaling activity of the plurality of frequency bands.

39. The computer-readable medium of claim 38, wherein the one or more processors are further to:
measure signaling activity for the two or more frequency bands simultaneously.

40. The computer-readable medium of claim 35, wherein the UE operates in a New Radio (NR) Radio Access Technology (RAT) environment of the RAN node.

41. A method, performed by a User Equipment (UE), comprising:
matching a carrier combination supported by a Radio Access Network (RAN) node to a plurality of frequency bands used by the RAN node, the carrier combination including a plurality of component carriers;
identifying a measurement gap status for each component carrier of the plurality of component carriers;
determining two or more frequency bands, of the plurality of frequency bands, that the UE can measure in parallel;
determining a number of effective frequency bands, based on a total number of the plurality of frequency bands, where the two or more frequency bands that UE can measure in parallel are considered, in determining the number of effective frequency bands, as a single frequency band; and
communicating, to the RAN node, the number of effective frequency bands and the measurement gap status for each component carrier of the plurality of component carriers.

42. The method of claim 41, further comprising:
receiving the carrier combination and the plurality of frequency bands from the RAN node.

43. The method of claim 41, further comprising:
receiving an indication, from the RAN node, to use the carrier combination for communicating with the RAN node.

44. The method of claim 43, further comprising:
receiving an indication, from the RAN node, to periodically measure signaling activity of the plurality of frequency bands.

45. The method of claim 44, further comprising:
measuring signaling activity for the two or more frequency bands simultaneously.

46. The method of claim 41, wherein the UE operates in a New Radio (NR) Radio Access Technology (RAT) environment of the RAN node.

47. An apparatus of a User Equipment (UE), the apparatus comprising:
means for matching a carrier combination supported by a Radio Access Network (RAN) node to a plurality of frequency bands used by the RAN node, the carrier combination including a plurality of component carriers;
means for identifying a measurement gap status for each component carrier of the plurality of component carriers;
means for determining two or more frequency bands, of the plurality of frequency bands, that the UE can measure in parallel;
means for determining a number of effective frequency bands, based on a total number of the plurality of frequency bands, where the two or more frequency bands that UE can measure in parallel are considered, in determining the number of effective frequency bands, as a single frequency band; and
means for communicating, to the RAN node, the number of effective frequency bands and the measurement gap status for each component carrier of the plurality of component carriers.

48. The apparatus of claim 47, further comprising:
means for receiving the carrier combination and the plurality of frequency bands from the RAN node.

49. The apparatus of claim 47, further comprising:
means for receiving an indication, from the RAN node, to use the carrier combination for communicating with the RAN node.

50. The apparatus of claim 47, further comprising:
means for receiving an indication, from the RAN node, to periodically measure signaling activity of the plurality of frequency bands.
